(19) United States
(12) Patent Application Publication
(10) Pub. No.: US 2001/0055507 A1
(43) Pub. Date: Dec. 27, 2001

(54) Printer, form printer, printer control method and print controller

(75) Inventor: Isamu Tobita, Yamato-shi (JP)

Correspondence Address: Lawrence R. Fraley, IBM Corporation, N50/040-4, 1701 North Street, Endicott, NY, 13760, US

(73) Assignee: International Business Machines Corporation, Armonk, NY

(21) Appl. No.: 09/886,200

(22) Filed: Jun. 21, 2001

(30) Foreign Application Priority Data
Jun. 26, 2000 (JP) 2000-191572

(51) Int. Cl. G06F 11/00; B41J 5/30

(52) U.S. Cl. 400/76; 400/61

(57) ABSTRACT

An impact printer comprising pins for providing an impact and an impact force controller for changing the force with which the pins impact in accordance with the settings for characters that are to be printed. A form printer further including a drive unit and control means for controlling the drive unit is also provided. A method for controlling such a printer, is further included, which comprises the steps of identifying a character set to be printed and generating pin impact power according to the set.

### FIELD OF THE INVENTION

The present invention relates to a printer for printing vouchers, a form printer, a printer control method and a printing controller.

### BACKGROUND OF THE INVENTION

Impact printers are employed for printing characters on objects, such as multipart forms for which pressure sensitive paper or carbon paper is used. The print head of an impact printer includes typically a plurality of dot pins, a drive mechanism for reciprocally extending the individual dot pins toward an object, such as a multipart form, and an ink ribbon positioned between the dot pins and the print object.

To perform printing using such a print head, when the dot pins are extended by the drive mechanism, the distal ends thereof strike a print object, in this case, a multipart form, and via the ink ribbon positioned between the multipart form and the dot pins, characters are printed, as dots, on the top sheet. At the same time, beneath the top sheet, the force with which the dot pins strike the multipart form causes corresponding dots to be produced on sheets of pressure sensitive paper, or causes dots to be transferred from carbon paper to facing, untreated sheets. In either event, the characters that are printed, as dots, on the top sheet are also printed on each of the lower sheets. While the print head is moved along a print object, multiple dot pins are moved in the above described manner to form, from dots, a plurality of characters, in order to perform a predetermined printing task.

One problem encountered with the above impact printer is that as the number of sheets in a multipart form is increased, the density of the printing on the bottom sheet is reduced. Furthermore, when the density of the printing of individual dots is reduced, the visibility of the characters thus printed differs, depending on the thicknesses thereof. That is, a fine character, for which thin lines are used that are only one dot wide, will be less visible than a character for which thick lines are used that are several dots wide.

To resolve this problem, the force with which each dot pin strikes a printing object must be increased. However, if the pressure applied by dot pins is merely increased, because of the additional wear and tear that this will impose, ink ribbons will have to be replaced more frequently, the abrasion of dot pins will be accelerated, and more noise will be generated during printing.

For driving the dot pins, normally a coil is employed. This coil is magnetized or demagnetized by switching on or off the power transmitted to it, and accordingly, the dot pins are actuated and reciprocally moved. For this drive mechanism, when the current supplied to the coil is increased to magnify the pressure applied by the dot pins, there is a like increase in the generation of heat by the coil, which has an adverse affect on the continuous employment of the coil.

It is believed, therefore, that a printer which overcomes the aforementioned disadvantages would constitute an advancement in the art.

### SUMMARY OF THE INVENTION

To resolve the above technical shortcomings, it is one object of the present invention to provide a printer, a form printer, a printer control method and a printing controller, all of which can enhance the visibility of printed images, such as characters.

According to one aspect of the invention, an impact printer is provided which comprises pins for providing an impact, and an impact force controller for changing the force with which the pins impact in accordance with the settings for characters that are to be printed.

When the thus arranged printer changes the force with which the pins impact, the density of the dot printing performed on each sheet of a multipart form is changed. That is, when the force of impact is changed in accordance with the settings for the characters that are printed as dots, e.g., in accordance with the thicknesses or the fonts of the characters, the visibility of printed characters can be increased. As one example of a specific method for changing the force of impact, a current, which is supplied to a coil that uses magnetic force to drive pins, need only be changed in consonance with an alteration of the time period allocated for magnetization and of the voltage that is employed in order for the magnetic force generated by the coil to be changed. The impact force can also be changed by altering the number of pulse current generations performed during a predetermined period of time.

A form printer according to another aspect of the present invention comprises a plurality of pins for impacting a form on a platen, a drive unit, for reciprocally driving the pins in forward and backward directions, and a controller, for controlling the drive unit and for changing, in accordance with the types of characters that are to be printed, the impact force transmitted by the pins. Furthermore, the velocity of the pins may also be changed in order to alter the impact force.

A plurality of character sets can be printed by the printer. When a character to be printed belongs to a first character set wherein many thick characters are included, the controller reduces the impact force transferred by the pins, and when a character to be printed belongs to a second character set wherein many fine characters are included, the controller increases the impact force. Therefore, since the impact force is reduced for the first character set, wherein many thick characters are included, pin abrasion can be reduced, and since the impact force is increased for the second character set, wherein many fine characters are included, the printing density and visibility of characters can be improved.

The terms “thick characters” or “fine characters” as used here merely indicate that the characters belong to a character group for which wide lines are used or to a character group for which narrow lines are used. The use of these terms is not intended to establish specific values for limiting the thicknesses of individual characters.

A printer according to yet another aspect of the present invention is provided which is designed such that the impact force transferred by the pins is changed in accordance with the number of dots arranged across the width of a line used in a print image. In addition, a plurality of levels are prepared for the impact force modes, and the modes may be selected in accordance with the number dots arranged across the width of a line. When the impact force is changed in this manner, the print density of each dot is varied, and if the width of a line is only one dot, by increasing the impact force a greater print density is provided for the individual dots in a line, so that the visibility of the line is improved. When two or more dots are arranged across the width of a line, the visibility of the line is higher than is that of a line having a single dot width when the same dot print density is used. Therefore, even when, as in this case, the impact force is less than that employed for printing a one dot wide line, the line formed by the dots is satisfactorily visible.

According to still another aspect of the present invention, a method for controlling a printer is provided wherein pins are used to impact a print object and wherein, to print a plurality of character sets, a plurality of dots is so printed. The method comprises the steps of identifying a character set to be printed and using the pins (in accordance with the specifications for the character set), to transfer the impact force. Since the character set is identified, an impact force consonant with the character set can be set. Therefore, it is preferable that, in accordance with the character sets that are to be used, multiple impact force levels be prepared in advance.

According to another aspect of the present invention, a printing controller is provided which prints characters formed by dots by using pins to transfer an impact force to a receiving sheet. The controller comprises a data analyzer, for determining the type of character set included in the print data and a printer head controller for employing the determination results obtained by the data analyzer to change the impact force transferred by the pins. The data analyzer can determine a type of the character set in accordance with a predetermined command that is entered when a character font is to be changed, and an impact force value that corresponds to the character font that can be selected from among multiple preset values.

### BRIEF DESCRIPTION OF THE DRAWINGS

FIG. 1 is a diagram showing the configuration of a form printer according to one embodiment of the present invention.

FIG. 2 is a diagram showing the principle applied for the driving of the pins of the form printer of FIG. 1.

FIG. 3 is a diagram showing an example of an arrangement of the pins used herein.

FIGS. 4(a) and 4(b) are diagrams showing two example character sets that are to be printed by the form printer.

FIGS. 5(a) and 5(b) are diagrams showing the magnetization timings for a coil that correspond to the example character sets in FIGS. 4(a) and 4(b).

FIG. 6 is a flowchart showing a normal printing processing.

FIG. 7 is a flowchart showing the processing performed to change the print mode.

### DETAILED DESCRIPTION OF THE PREFERRED EMBODIMENTS

The present invention will now be described in detail, while referring to the accompanying drawings. Defined herein will include a printer, a form printer, a printer control method and a printing controller, all in accordance with the preferred embodiments thereof.

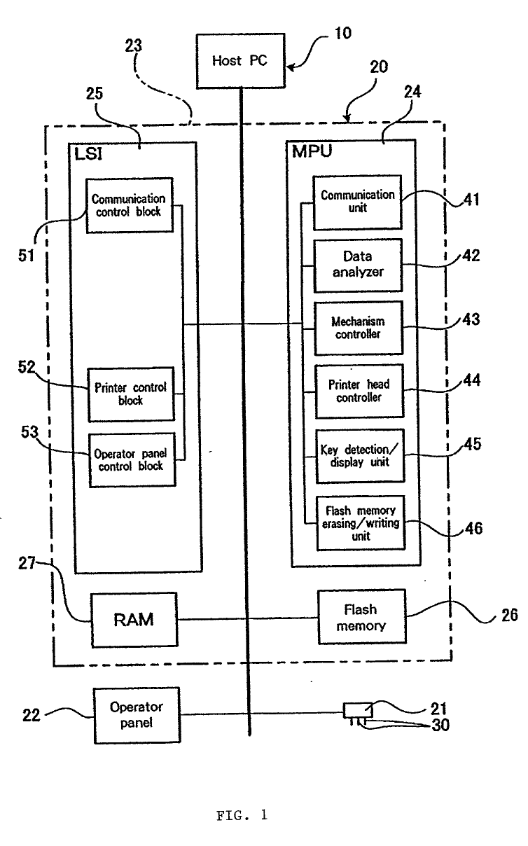

FIG. 1 is a schematic diagram for explaining the configuration of a form printer according to one embodiment of this invention. An impact form printer 20 is controlled by a host PC 10, and performs predetermined printing tasks for a voucher comprised of a plurality of sheets (or forms). A printer head 21 includes a plurality of dot pins 30 and an operator panel 22 is used by the operator to operate printer 20. Additionally, a control unit (impact force controller and printing controller) 23 controls the overall operations of form printer 20.

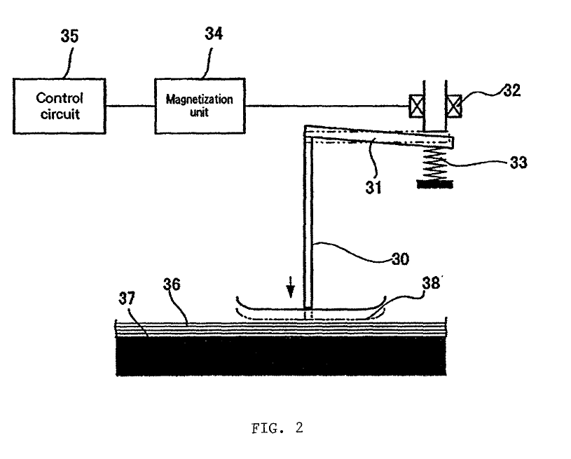

FIG. 2 is a side elevational view showing the principle of the process used for driving dot pins 30. As is shown in FIG. 2, individual dot pins 30 (only one being shown in FIG. 2 for ease of illustration) in the printer head 21 are integrally formed at the distal end of a magnetic arm 31. The arm 31 that is provided is pivotable at a fulcrum (not shown). A coil 32 and spring 33, for pivoting arm 31, are located at the base end of arm 31. A magnetization unit (magnetization means) 34 is provided for coil 32, and, when the magnetization unit 34 renders the coil 32 on or off, the coil is magnetized or demagnetized. Operation of magnetization unit 34 is controlled by control circuit 35. To print the first sheet of voucher 36 (comprised of several stacked forms), an ink ribbon 38 is located between the distal ends of the dot pins and a platen 37 on which the voucher is held.

When coil 32 is activated by magnetization unit 34, under the control of control circuit 35, the coil is magnetized and attracts the base end of arm 31. Accordingly, arm 31 pivots and dot pin 30 is projected (the state indicated by the phantom lines in FIG. 2). Then, when under the control of circuit 35, the coil is turned off by the magnetization unit, such that the coil is demagnetized. As a result, the base end of arm 31 is retracted by spring 33 and dot pin 30 is returned to its original position (the state indicated by the solid lines in FIG. 2).

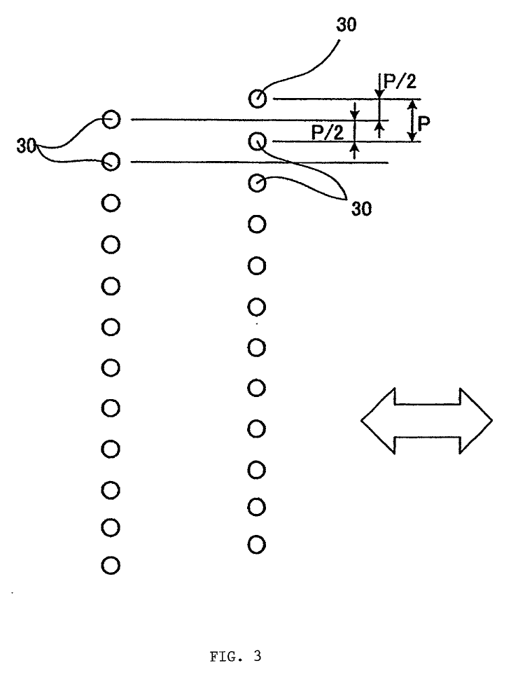

As is shown in FIG. 3, the printer head 21 includes, for example, a total of twenty-four dot pins 30. Various arrangements are used for the pins, but in this embodiment, as an example, a zigzag arrangement is employed. The dot pins are arranged in two rows of 12 pins each, and in each row, the dot pins 30 are located substantially linearly at predetermined intervals P. The dot pins 30 in one row are shifted relative to the dot pins in the other row a distance equal to half that represented by the predetermined interval P, i.e., a distance P/2. When the arranged printer head 21 is moved along voucher 36 in the direction indicated by arrows in FIG. 2, a total of twenty-four dot pins 30 are positioned at P/2 intervals in the direction perpendicular to the direction of movement. Printer head 21 is reciprocally moved along the surface of voucher 36 by a drive mechanism (not shown) that is also controlled by control circuit 35. The voucher 36 mounted on platen 37 is fed by a feeding mechanism (also not shown) in the direction perpendicular to the direction of movement of printer head 21. Feeding mechanisms are known in the art and further description is not believed necessary.

The operator panel 22 in FIG. 1 includes operation keys (not shown), which are manipulated by an operator to control the form printer 20, and a display portion (not shown), on which control information and manipulation information are displayed for the operator. These keys and display can be conventional components, and description is not necessary.

Control unit 23 comprises an MPU (micro processing unit) 24 for performing predetermined processing, an LSI (large scale integration) circuit 25 for controlling the overall form printer 20, a flash memory 26 (which is nonvolatile memory), and a random access memory (RAM) 27, for the temporary storage of data.

MPU 24 includes a communication unit 41 (for exchanging control signals with the host PC 10), a data analyzer 42 (for analyzing data received by the communication unit 421 and for outputting the results to the individual sections), a mechanism controller 43 (for controlling the individual mechanisms, such as the printer head 21, the mechanism for feeding the print object (not shown) and the mechanism for feeding the ink ribbon 38), a printer head controller 44 (for controlling the movements of the printer head 21 and the dot pins 30), a key detection/display unit 45 (for detecting the state of the key manipulated on the operator panel 22, and for outputting information that is to be displayed on the display portion (not shown)), and a flash memory erasing/writing unit 46 (for erasing data from or writing data to the flash memory 26).

LSI circuit 25 includes a communication control block 51 (for controlling the communication performed by the communication unit 41 based on a predetermined program), a printer control block 52 (for controlling the operation of the printer head 21 based on the processing performed by the printer head controller 44), and an operator panel control block 53 (for executing an operation that is entered at the operator panel 22 and is displayed by the key detection/display unit 45, and for controlling the information presented on the display portion (not shown) of the operator panel 22).

In accordance with a set (setting, font, etc.) of characters (images) to be printed, specifically, the thickness of the characters, the form printer 20 changes the impact force that is to be transferred to voucher 36 by the individual dot pins 30. To change the impact force, the period of time (hereinafter referred to as the “fire time”) allocated for magnetizing the coil 32 of the printer head 21 is adjusted.

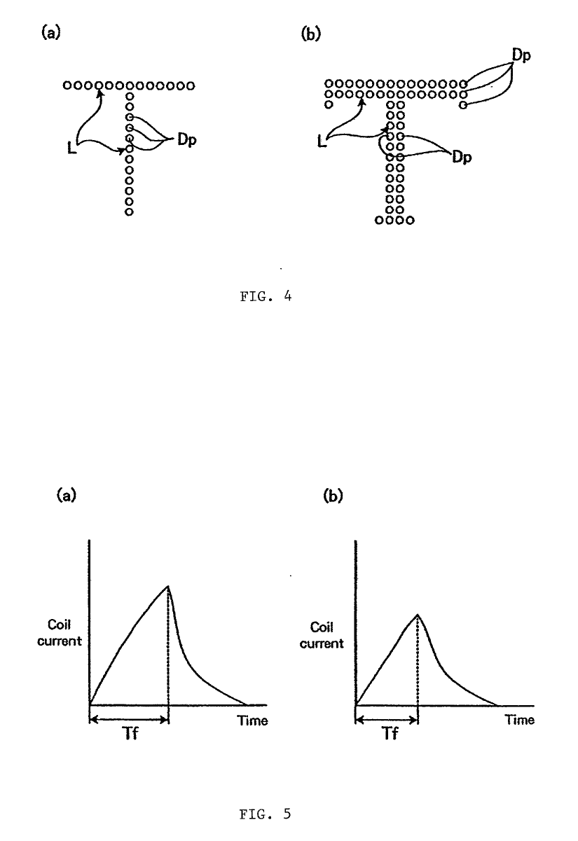

To print a character where, as shown in FIG. 4(a), only one dot Dp is located across the width of each line L that forms pertinent character, control unit 23 sets the print mode to the single byte character set mode (hereinafter referred to simply as an “SBCS”), which is the first character set. Thereafter, to print a character wherein, as is shown in FIG. 4b, a plurality of dots DP (two dots in the example) are arranged across the width of each line L that forms the pertinent character, e.g., to print a Chinese character, the control unit 23 sets the print mode to a double byte character set mode (hereinafter referred to simply as a “DBCS”), which is the second character set.

In FIGS. 5(a) and 5(b), fire times Tf are shown for the SBCS mode and for the DBCS mode, respectively. The fire time Tf set for the coil 32 in the DBCS mode is seen to be shorter by a predetermined time than is the fire time in the SBCS mode. More specifically, when the fire time Tf in the SBCS mode is set, for example, to 320[μsec], the fire time Tf in the DBCS mode is set, for example, to 300[μsec]. Understandably, these are examples and other values are possible. When the fire time Tf differs in the SBCS mode and in the DBCS mode, the impact force exerted by the dot pins is changed. As the fire time Tf is extended, the magnetized state period of the coil is also extended, and the magnetic force is increased. Accordingly, arm 31 (FIG. 2) is more strongly attracted by the magnetized coil 32, e.g., the speed of movement of the dot pins is increased. As a result, the impact force transferred to the voucher by the dot pins is increased.

In comparison, when the fire time Tf is reduced, the magnetized state period of the coil is also shortened, and the speed of movement of the dot pins is reduced, so that the impact force transferred to the voucher by the dot pins is also reduced.

When an impact force at two levels, high and low, is transferred to the dot pins, the print density of the dots Dp at the high impact force (the SBCS mode) is increased, while the print density at the low impact force (the DBCS mode) is reduced.

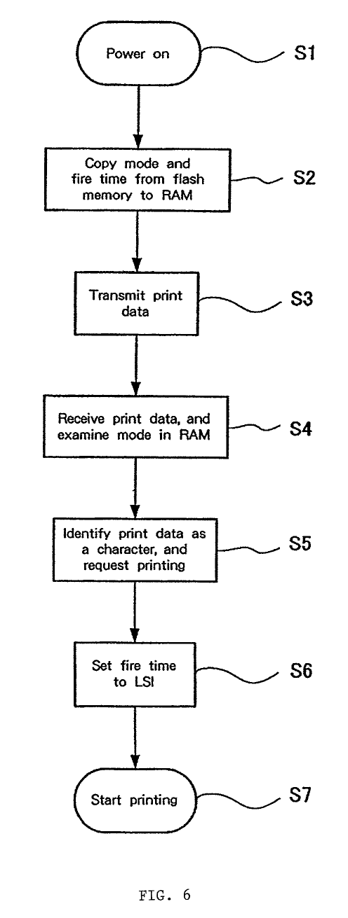

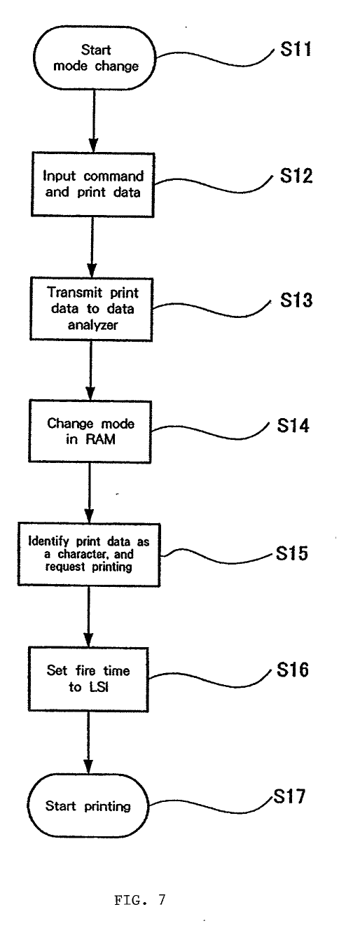

FIG. 6 is a flowchart showing the processing performed by the control unit 23 during the printing performed by the form printer 20.

The initial printing mode of the form printer 20 in FIG. 1 can be set to either the SBCS mode or the DBCS mode by using a predetermined operation. Once the initial mode has been set, this setting is stored in the flash memory 26, and even when the printer 20 is powered off, the setting is maintained. In this embodiment, for example, the printing mode is initially set to the SBCS mode. To switch the printing mode off-line, (from the SBCS mode to the DBCS mode, or from the DBCS mode to the SBCS mode) the initial setting need only be performed in the above described manner.

To initiate printing using form printer 20, the form printer is powered on (step S1 in FIG. 6), following which the initial print mode (e.g., the SBCS mode) and the corresponding fire time Tf (see FIG. 5(a) are read from flash memory 26 and are copied to RAM 27 (step S2).

Next, host PC 10 transmits print data to form printer 20 (step S3 in FIG. 6). The print data is a data stream having a predetermined form that includes data (e.g., “X1”) representing the print mode (SBCS mode) and comprised of characters to be printed and data (“ABC”) for the pertinent characters (e.g., ABC). Upon receipt of the print data, the communication unit 41 of the form printer copies the print data to RAM 27, and also transmits it to the data analyzer 42 (Step S4). The data analyzer 42 analyzes and identifies the print data, and issues a request to the mechanism controller 43 for the printing of the character data “ABC” included in the print data. Then, the mechanism controller 43 issues a printing request to the printer head controller 44 (step S5). The printer head controller 44 examines the print mode data “X1” (SBCS mode) and the fire time Tf that are currently stored in the RAM 27, and sets the print mode (SBCS mode) and the corresponding fire time Tf in the printer controller 44 of LSI 25 circuit (step S6). Thereafter, the printer head controller 44 issues a print start request to the printer control block 52 of LSI circuit 25. Upon the receipt of this request, the printer control block 52 outputs, to the control circuit 35 of printer head 21 in FIG. 2, the character data and a printing command that is based on the designated print mode (SBCS mode), and a fire time Tf.

The control circuit 35 (FIG. 2) employs the drive mechanism (not shown) to move the printer head 21 along the surface of the voucher 36 at a predetermined speed, and also permits the magnetization unit 34 to drive specific dot pins 30. As a result, the printing of the characters ABC, based on the character data “ABC,” is initiated in the designated print mode (SBCS mode) (step S7). At this time, to begin the printing of the characters ABC, the coil 32 is excited by the magnetization unit 34 during the designated fire time Tf, and a predetermined impact force which corresponds to the designated print mode (SBCS mode), is transferred to the voucher 36 on the platen 37 by the driven dot pins 30.

When, to perform printing, the print mode is to be changed (from the SBCS mode to the DBCS mode) in the current on-line state, the processing shown in FIG. 7 is performed. First, while the form printer 20 continues to print in, for example, the SBCS mode, the host PC 10 determines that the print data for the next characters (e.g., DEF) is DBCS mode (not shown in FIG. 7 because this process is performed by the host PC 10). Then, in order to change from the currently designated SBCS print mode to the DBCS print mode, the host PC 10 outputs, to the form printer 20, print data that includes a predetermined mode change command (e.g., “XY1”; a command for changing a mode) and data (“DEF”) for the characters DEF. As a result, the mode change process is initiated (step S11). When form printer 20 receives the print data, including the mode change command “XY1 ” (step S12), the communication unit 41 copies the print data, including the mode change command “XY1,” to RAM 27, and also transmits the print data to data analyzer 42 (step S13).

Data analyzer 42 now identifies the mode change command “XY1 ” included in the print data, and changes the print mode to the DBCS mode. Then, data analyzer 42 reads, from flash memory 26, the fire time Tf (again see FIG. 5(b)), which corresponds to the DBCS mode, and stores it in RAM 27 (step S14). Thereafter, the data analyzer 42 issues, to the mechanism controller 43, a request for the printing of the print data “DEF” included in the received print data, and the mechanism controller 43 issues a printing request to the printer head controller 44 (step S15). The printer head controller 44 examines the print mode (DBCS mode) and the fire time Tf that are currently stored in RAM 27, and notifies the printer head controller 44 of the LSI 25 circuit (step S16) that the fire time Tf is to be used for the DBCS mode. Following this, the printer head controller 44 issues a printing start request to the printer control block 52 of LSI circuit 25. Upon receipt of this request, the printer control block 52 outputs, to the control circuit 35 of the printer head 21 in FIG. 2, the character data “DEF” and a print command that is based on the designated print mode (DBCS mode) and fire time Tf. As a result, the printing of the characters DEF is initiated based on the print data and on the designated print mode (SBCS mode) (step S17).

To change from the DBCS mode to the SBCS mode, the above described process need only be performed using the print data that include a corresponding, predetermined mode change command (e.g., “YX1”).

To print a fine character, such as the one in FIG. 4(a), using form printer 20, the fire time Tf for the coil 32 is extended and the impact force is increased. To print a thick character, such as the one in FIG. 4b, the fire time Tf for the coil 32 is shortened and the impact force is reduced. Thus, the printing density of the dots Dp are changed. And, even when fine characters are to be printed on a great number of multipart forms, accurate printing is ensured, especially on the bottom sheet, and the visibility of characters is enhanced. Further, since thick characters are printed using a low impact force (DBCS mode), the abrasion of the dot pins 30 and the consumption of ink ribbon 38 can be suppressed while maintaining the visibility of the printed characters, so that the labor required for maintenance and the costs can be reduced, and the noise produced during printing can also be lowered.

In addition, the mechanical structure of form printer 20 is the same as a conventional printer, and only the magnetization time for the coil 32 need be controlled. As a result, the above effects can be obtained at a low cost.

Furthermore, for the form printer 20, the print data, including a predetermined mode change command, can be employed to easily change the print mode while the on-line state is maintained.

In the above embodiment, the impact force has been changed simply in accordance with the character type. However, the impact force may also be changed in accordance with the character type and the number of sheets used for voucher 36. Further, when the form printer 20 is used to update a bankbook, for which it is well known that only the printing of the first sheet is usually required, the form printer 20 need only be set to the DBCS mode, and a low impact force employed for printing this first sheet.

In the above embodiment, the SBCS mode and the DBCS mode have been prepared for the print mode, and the impact force has been changed at only these two levels. However, it is understood that the impact force may be changed at more levels than just these two.

The print mode may be changed at any time. For example, the character type to be printed is repeatedly examined, and when the character type is changed from a font for fine characters to one for thick characters, the print mode may be automatically changed. Moreover, the magnetization time for the coil 32 may be changed in order to alter the impact force. Instead of this, another method can be employed; for example, the value of the current supplied to the coil 32 may be changed, or the magnetization voltage may be altered. Further, the impact force can also be changed by altering the number of pulses generated during a predetermined period of time.

The print mode changing method is not limited to the method described in the embodiment, and another method can be employed.

The character set to be printed is not limited to those shown in FIGS. 4(a) and 4(b), and the number of dots Dp arranged across the width of the lines L that form a character is not limited to one or two, and may in fact be greater. Furthermore, the images that are to be printed are not limited to characters, and may be other objects.

The structures of the individual sections of form printer 20 in this embodiment can be modified without departing from the scope of the invention. For example, an arbitrary structure can be employed for the structure of the printer head 21 or for the driving method and the structure of the dot pins 30, just so long as required functions will be carried out. The same applies to the arrangement and the count of dot pins 30.

In the above embodiment, a form printer 20 that prints a voucher 36 has been employed; however, it is known that the application of an impact printer is not limited to vouchers or to bankbooks.

As described above, according to the present invention, when the printing density is varied by changing the impact force transferred by the dot pins, the visibility of printed images can be increased, and abrasion of the pins and the noise generated during the printing will be reduced.

While there have been shown and described what are at present considered to be the preferred embodiments of the invention, it will be obvious to those skilled in the art that various changes and modifications may be made therein without departing from the scope of the invention as defined by the appended claims.

What is claimed is:

1. An impact printer comprising:
pins for providing an impact; and
an impact force controller for changing the force with which the pins impact in accordance with the settings for characters that are to be printed.

2. An impact printer comprising:
pins for providing an impact;
an impact force controller for changing the force with which the pins impact in accordance with the settings for characters that are to be printed;
drive means having a coil for driving the pins using magnetic force generated by electricity; and
electricity supply means for supplying electricity to the coil, wherein the impact force of the pins are changed according to changes of the magnetic force.

3. The impact printer according to the claim 2, wherein the impact force controller changes a supply time or a voltage of the electricity to the drive means.

4. A form printer comprising:
a plurality of pins, for impacting a form on a platen;
a drive unit, for reciprocally driving the pins in both forward and backward directions relative to the form on the platen; and
a controller for controlling the drive unit and for changing the impact force of the pins, in accordance with the types of characters that are to be printed.

5. The form printer according to the claim 4, wherein the moving velocity of the pins is changed in order to alter the impact force.

6. A form printer comprising:
a plurality of pins, for impacting a form on a platen;
a drive unit, for reciprocally driving said pins in both forward and backward directions; and
a controller for controlling the drive unit and for changing the impact force of the pins, in accordance with the types of characters that are to be printed, wherein a plurality of character sets are printed and wherein, when a character to be printed belongs to a first character set in which thick characters are included, the controller reduces the impact force transferred by the pins and further wherein, when a character to be printed belongs to a second character set in which fine characters are included, the controller increases the impact force.

7. A printer, which forms multiple dots by transferring an impact force to an object and printing an image, comprising:
a plurality of pins, for transferring the impact force; and
impact force controller, for changing the impact force exerted by the plurality of pins in accordance with the number of dots that are arranged across the widths of lines forming the print image.

8. A printer, which forms multiple dots by transferring an impact force to an object and printing an image, comprising:
pins for transferring the impact force; and
impact force controller, for changing the impact force exerted by the pins in accordance with the number of dots that are arranged across the widths of lines forming the print image, wherein the impact force is set to a mode at one of a plurality of levels, and the impact force controller changes the mode in accordance with the number of dots that are arranged across the widths of lines forming an object image.

9. The printer according to the claim 8, wherein, the command for changing the mode is included in print data for a character, and the impact force controller changes the mode in response to said mode.

10. A method for controlling a printer, whose pins impact a print object and print a plurality of dots of a plurality of character sets, comprising the steps of:
identifying a character set to be printed; and
generating impact power to the pins in accordance with the types of the identified character set.

11. A printing controller, for a printer that by transferring an impact force using pins forms dots and prints characters on a sheet, comprising:
a data analyzer, for determining the type of character set included in print data; and
a printer head controller, for employing the determination results obtained by the data analyzer to change the impact force transferred by the pins.

12. A printing controller, for a printer that by transferring an impact force using pins forms dots and prints characters on a sheet, comprising:
a data analyzer, for determining the type of character set included in print data in accordance with the predetermined command that is entered when a character font is to be changed; and
a printer head controller, for employing the determination results obtained by the data analyzer to change the impact force transferred by the pins.

13. A printing controller, for a printer that by transferring an impact force using pins forms dots and prints characters on a sheet, comprising:
a data analyzer, for determining the type of character set included in print data in accordance with the predetermined command that is entered when a character font is to be changed; and
a printer head controller, for employing the determination results obtained by the data analyzer to change the impact force transferred by the pins, the printer head controller selecting and designating one setup value that corresponds to a character font from among values that are prepared for a plurality of levels to control the impact force transferred by the pins.
